(19) United States
(12) Patent Application Publication
(10) Pub. No.: US 2015/0134539 A1
(43) Pub. Date: May 14, 2015

(54) SYSTEM AND METHOD OF PROCESSING POINT-OF-SALE PAYMENT TRANSACTIONS VIA MOBILE DEVICES

(71) Applicant: Shashi Kapur, Fort Lauderdale, FL (US)

(72) Inventor: Shashi Kapur, Fort Lauderdale, FL (US)

(21) Appl. No.: 14/077,453

(22) Filed: Nov. 12, 2013

(51) Int. Cl. G06Q 20/40; G06Q 20/32; G06Q 20/10; G06Q 20/20

(52) U.S. Cl. CPC G06Q 20/4012; G06Q 20/20; G06Q 20/322; G06Q 20/10
USPC 705/72

(57) ABSTRACT

A system and method for processing POS payment transactions via mobile devices is described. Encrypted first identification information is received from a merchant mobile device. Encrypted second identification information is received from a cardholder mobile device. A determination is made regarding whether the encrypted first identification information and the encrypted second identification information are associated with one another. In response to a determination that the determination that the encrypted first identification information and the encrypted second identification information are associated with one another, the encrypted first identification information and the encrypted second identification information are decrypted. The POS payment transaction is processed based on the decrypted first and second identification information.

### FIELD OF THE INVENTION

The invention relates to processing point-of-sale (POS) payment transactions. In particular, the invention relates to processing POS payment transactions using mobile device(s).

### BACKGROUND OF THE INVENTION

Secure Personal Identification Number (PIN)-based authentication for POS payment transactions may require input of the PIN by a cardholder, typically via a PIN pad in brick-and-mortar location. There exists a need for performing and processing secure PIN-based authentication for POS payment transactions using mobile device(s).

### SUMMARY OF THE INVENTION

Various systems, computer program products, and methods for processing POS payment transactions via mobile devices are provided. According to various implementations of the invention, a method of processing a POS payment transaction via a mobile device may include receiving, from a merchant mobile device, encrypted first identification information, which identifies an account to be used for the POS payment transaction.

In some implementations of the invention, the method may include receiving, from a cardholder mobile device, a PIN associated with the account. The PIN is used to authenticate the POS payment transaction. In some implementations of the invention, the method may include receiving an encrypted PIN from the cardholder mobile device.

In some implementations of the invention, the method may include determining whether the encrypted first identification information and the encrypted PIN are associated with the POS payment transaction. In some implementations of the invention, the method may include decrypting the encrypted first identification information and the encrypted PIN. In some implementations of the invention, the method may include processing the POS payment transaction based on the decrypted first identification information and the decrypted PIN.

### BRIEF DESCRIPTION OF THE DRAWINGS

FIG. 1 is a block diagram illustrating an example of a system for processing POS payment transactions according to various implementations of the invention.

FIG. 2 illustrates an exemplary screenshot depicting an interface associated with a merchant mobile device, according to various implementations of the invention.

FIG. 3 illustrates an exemplary screenshot depicting an interface associated with a customer mobile device, according to various implementations of the invention.

FIG. 4 is a data flow diagram illustrating an example flow of data of a system for processing POS payment transactions according to various implementations of the invention.

FIG. 5 is a flow diagram illustrating an example of a process of processing a POS payment transaction at an adaptive payment server, according to various implementations of the invention.

### DETAILED DESCRIPTION

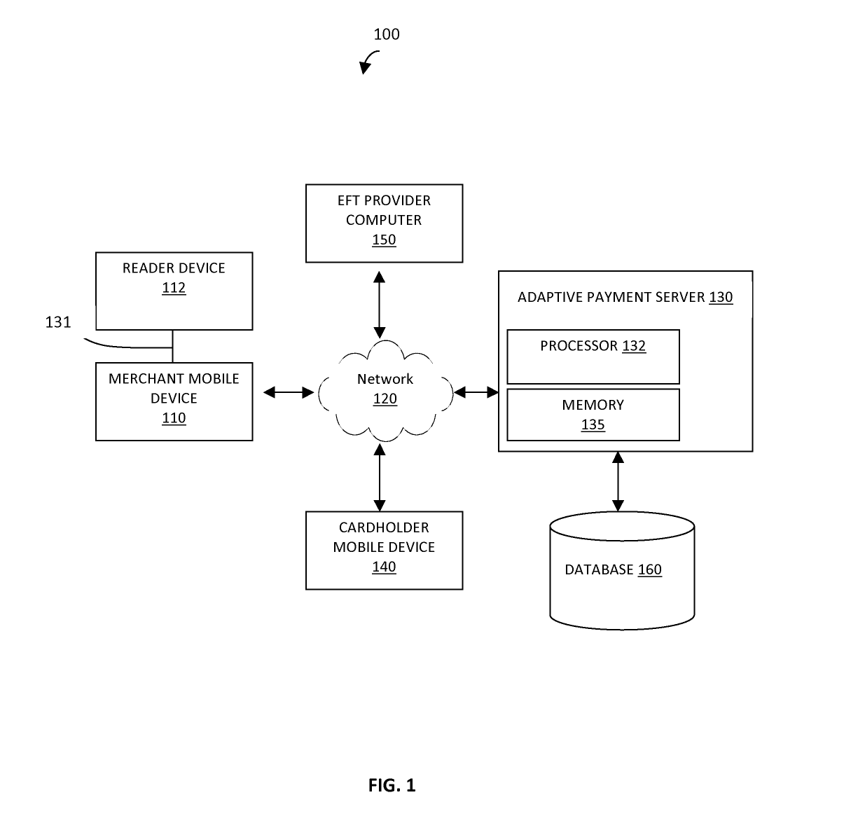

According to various implementations of the invention, various systems and methods may facilitate secure point-of-sale (POS) payment transactions via mobile devices. FIG. 1 is a block diagram illustrating a system 100 for processing POS payment transactions via mobile devices, according to various implementations of the invention. In some implementations of the invention, system 100 may be used to process a POS payment transaction between a merchant and a cardholder. In some implementations, a POS payment transaction may include, for instance, a purchase of goods or services at a brick-and-mortar/retail merchant location, a purchase of goods or services at a virtual merchant location, such as, a call-in number or a website, a funds transfer (for example, Electronic Funds Transfer (“EFT”), which involves electronically transferring funds or money from one account to another) at a merchant location, and/or other transaction that transfers money to/from a financial account (also referred to as “EFTPOS”—electric funds transfer at point-of-sale), and/or other POS payment transaction. The transactions for any of the foregoing implementations may be accomplished via one or more mobile devices as will be discussed below.

In some implementations, an adaptive payment server may receive encrypted first identification information associated with a payment device (such as a debit card) from a merchant mobile device. The adaptive payment server may receive encrypted second identification information associated with the payment device from a cardholder mobile device. The adaptive payment server may determine whether the encrypted first identification information and the encrypted second identification information are associated with one another (i.e., are associated with the same POS payment transaction). The adaptive payment server may decrypt the first identification information and the second identification information and may process the POS payment transaction based on the decrypted first identification information and the second identification information.

According to various implementations of the invention, the first identification information may include, among other things, a credit card number, debit card number, a gift card number, a bank account number, or other identifier that identifies or that may be used to identify a financial account/payment account associated with the cardholder used for the POS payment transaction. The payment account may be associated with the payment device (for example, payment card). In some implementations, the first identification information may further include a name of the cardholder/account holder (such as a name of the user), a telephone number of the cardholder, a mailing address of the cardholder, and/or other information related to the payment transaction. According to various implementations of the invention, the second identification information may include a PIN. The PIN may include a conventional four-digit predefined secret associated with the financial account or other secret information used to authenticate the POS payment transaction.

According to various implementations of the invention, the first identification information may identify a payment account associated with the cardholder. The payment account may include a bank account, a debit account, and/or other financial account configured to handle electronic banking functions. The payment account may be associated with a debit card (for example, cardholder's debit card), or other electronic payment card, and/or other device that may be used to conduct transactions with and/or through the payment account. According to various implementations of the invention, the debit card may include a magnetic strip, a smart chip, and/or other tangible media configured to store the first identification information and/or other information.

In some implementations, the first identification information can be stored using various tangible media such as, for example, a magnetic strip, a smart chip, a Radio Frequency Identification (“RFID”) tag, other Near Field Communication (“NFC”) tag, and/or other tangible medium that can be used to store and retrieve first identification information. In some implementations, the medium may be coupled to various payment devices, which can include, for example, a payment card, a key fob, a mobile device (such as a mobile device having an NFC tag), or other devices that can house or otherwise be used to carry the medium.

The foregoing are non-limiting examples associated with various implementations of the invention. Other uses and implementations of system 100 with respect to various system components will be apparent to those skilled in the art based on the description below.

According to various implementations of the invention, system 100 may include, but is not limited to, a merchant mobile device 110, a reader device 112, a network 120, an adaptive payment server 130, a cardholder mobile device 140, an EFT provider computer 150, and a database 160. In some implementations of the invention, adaptive payment server 130, merchant mobile device 110, cardholder mobile device 140, EFT provider computer 150, and database 160 may be communicably coupled to one another via a network 120. Network 120 may include a Local Area Network, a Wide Area Network, a cellular communications network, a Public Switched Telephone Network, a wireless communications network, and/or other network or combination of networks.

In some implementations of the invention, system 100 may process POS payment transactions by gathering encrypted first identification information from the merchant mobile device 110 and encrypted second identification information from cardholder mobile device 140. According to various implementations of the invention, merchant mobile device 110 may include a mobile computing/processing device such as a wireless phone, a portable computer, a personal digital assistant (PDA), a smart phone, a tablet computing device, a web-enabled mobile telephone, a WAP device, and/or other portable computing device that may be utilized to communicate information with adaptive payment server 130. In some implementations, merchant mobile device 110 may include a data (or Internet) function configured to communicate data via network 120. In this manner, a merchant may use merchant mobile device 110 to communicate the first identification information and/or other information. Those having skill in the art will appreciate that the invention described herein may work with various system configurations.

In some implementations, reader device 112 and merchant mobile device 110 may be communicably coupled to one another via a bi-directional link 131, which can include a wired (such as via Universal Serial Bus, headphone/multi-function jack, or other wired link) or wireless link (such as BLUETOOTH or other wireless link). In some implementations, reader device 112 may be connected to or plugged in the merchant mobile device 110, wherein the reader device 112 may be configured to accept a payment device (for example, a payment card) associated with a user (cardholder/account holder) performing a POS payment transaction. In some implementations, the reader device 112 may be plugged into a headphone/audio jack of the mobile device 110. In some implementations, the reader device may be implemented as software configured to cause the merchant mobile device itself to read, for example, a smart chip of the cardholder's debit card via various wireless capabilities and functions of the merchant mobile device.

In some implementations, for example, reader device 112 may obtain first identification information from the payment device and encrypt the first identification information. In some implementations, reader device 112 may use Triple Data Encryption Algorithm (commonly known as “Triple DES”), Advanced Encryption Standard (“AES”), or other encryption techniques. In some implementations, reader device 130 uses Derived Unique Key Per Transaction (“DUKPT”) key management to further enhance security. In some implementations, merchant mobile device 110 may receive the encrypted first identification information via link 131 for processing a POS payment transaction.

In some implementations, reader device 112 may communicate the first identification information to merchant mobile device 110, wherein the merchant mobile device may encrypt the obtained first identification information substantially immediately upon receipt. In some implementations, merchant mobile device 110 may use Triple Data Encryption Algorithm (commonly known as “Triple DES”), Advanced Encryption Standard (“AES”), or other encryption techniques. In some implementations, merchant mobile device 110 uses Derived Unique Key Per Transaction (“DUKPT”) key management to further enhance security.

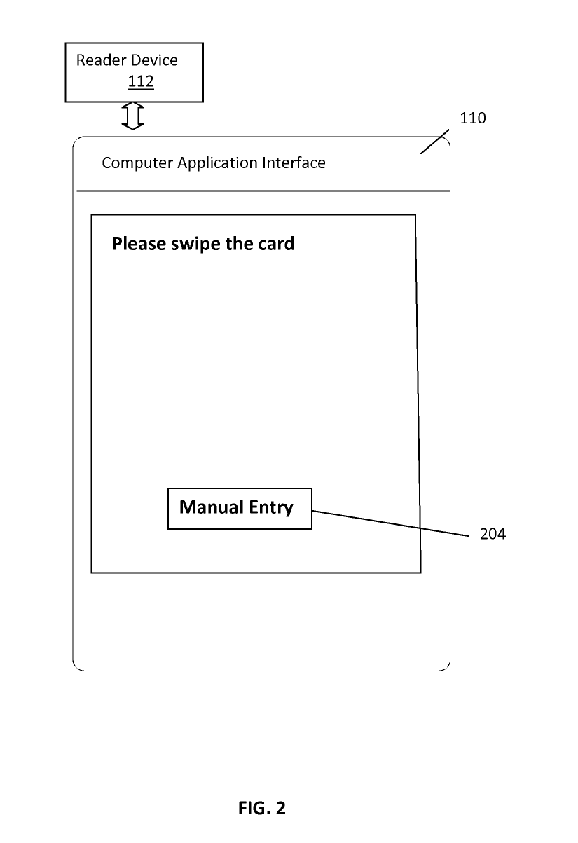

In some implementations, merchant mobile device 110 may be configured to provide encrypted first identification information to adaptive payment server 130 to facilitate a secure POS payment transaction. In some implementations, merchant mobile device 110 may include a processor (not otherwise illustrated in the Figures), circuitry, and/or other hardware operable to execute computer-readable instructions and/or mobile applications. In some implementations, merchant mobile device 110 may execute a merchant mobile application that is configured to generate a user interface and prompt the cardholder for the first identification information, and/or other information via the user interface, as depicted in FIG. 2, for example. In some implementations, the cardholder may be prompted for the first identification information in response to a purchase of an item at a merchant location. The purchase may have a payment amount associated with it (i.e., payment amount associated with the item(s) purchased). In some implementations, the merchant mobile application may prompt the cardholder to select the type of payment (for example, debit) for the purchase (i.e., to cover the payment amount).

In some implementations, the merchant mobile application may prompt the cardholder to swipe his/her debit card using the reader device 112. First identification information (e.g., debit card number, expiration date, card security code, and/or other information) may be read by the reader device 112 (for example, when a debit card is swiped or otherwise read using the reader device). The reader device 112 may provide the first identification information to the merchant mobile application. In some implementations, in response to a proper swipe, the merchant mobile application may cause a payment card swipe successful message to be displayed via the user interface of merchant mobile device 110. In some implementations, the cardholder may manually enter the payment card number, expiration date and/or card security code (if the card swipe was unsuccessful, for example) by selecting the manual entry option 204.

In some implementations, the merchant mobile application may encrypt the first identification information and may cause the encrypted first identification information and a payment amount associated with the transaction to be communicated to adaptive payment server 130 via network 120. In some implementations, merchant mobile device 110 may include a memory (not otherwise illustrated in the Figures) that includes one or more tangible (i.e., non-transitory) computer readable media. The memory may include one or more instructions that when executed by the processor configures the processor to perform functions of merchant mobile device 110/merchant mobile application.

In some implementations, reader device 112 may encrypt the first identification information and may provide the encrypted first identification information to the merchant mobile application. In some implementations, the merchant mobile application may cause the encrypted first identification information to be communicated to adaptive payment server 130 via network 120.

In some implementations, the merchant mobile application may cause the communication of location information associated with the merchant mobile device 110 (referred to as “merchant location information”) to the adaptive payment server 130 via network 120. In some implementations, the merchant mobile application may determine the location of the merchant mobile device 110 while the POS payment transaction is taking place at the merchant location (for example, the brick-and-mortar location). In some implementations, the merchant location information may be communicated to the adaptive payment server 130 along with the encrypted first identification information. In some implementations, the merchant location information may include, the GPS location coordinates of the merchant mobile device 110, date and time (which would also indicate the date and time of the POS payment transaction, for example).

Upon receiving the encrypted first identification information and/or other information, adaptive payment server 130 may cause communication of a confirmation page that indicates receipt of the first identification information to merchant mobile device 110. In some implementations, the confirmation page may include the payment amount associated with the POS payment transaction. In some implementations, the merchant mobile application executed by merchant mobile device 110 may cause the confirmation page to be displayed via the user interface of the merchant mobile device 110.

In some implementations, adaptive payment server 130 may generate a transaction identifier for the POS payment transaction. In some implementations, adaptive payment server 130 may generate the transaction identifier in response to receiving encrypted first identification information from the merchant mobile device 110. The transaction identifier may be one or more words, characters, numbers, and/or other identifier that may uniquely identify the POS payment transaction. Furthermore, the transaction identifier may be written, typed, and/or spoken. In this manner, the transaction identifier may be used to identify the POS payment transaction to the merchant, the cardholder and/or other entity using the merchant mobile device 110 and/or cardholder mobile device 140. According to various implementations of the invention, the confirmation page described above may include the transaction identifier. According to various implementations of the invention, the transaction identifier may be stored using database 160 for later retrieval by adaptive payment server 130.

According to various implementations of the invention, cardholder mobile device 140 may include a mobile computing/processing device such as a wireless phone, a portable computer, a personal digital assistant (PDA), a smart phone, a tablet computing device, a web-enabled mobile telephone, a WAP device, and/or other portable computing device that may be utilized to communicate information with adaptive payment server 130. In some implementations, cardholder mobile device 140 may include a data (or Internet) function configured to communicate data via network 120. In this manner, a cardholder may use cardholder mobile device 140 to communicate the second identification information and/or other information. Those having skill in the art will appreciate that the invention described herein may work with various system configurations.

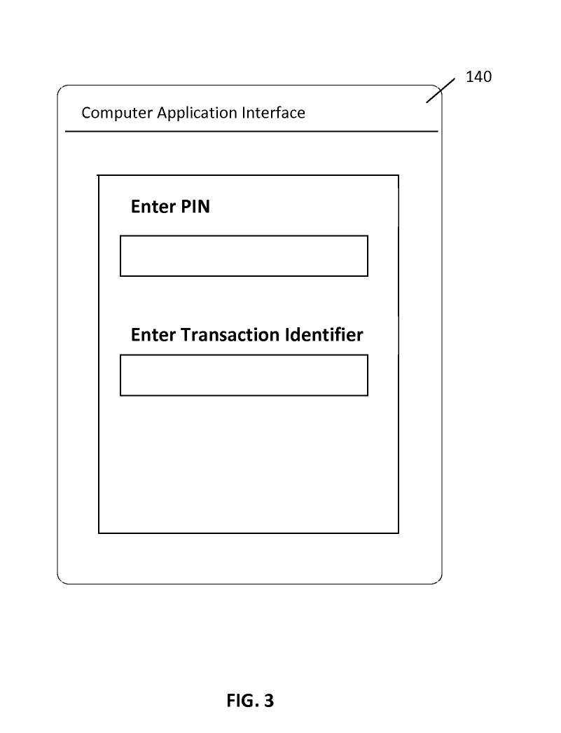

In some implementations, cardholder mobile device 140 may be configured to provide encrypted second identification information and/or other information to adaptive payment server 130 to facilitate the secure POS payment transaction. In some implementations, cardholder mobile device 140 may include a processor (not otherwise illustrated in the Figures), circuitry, and/or other hardware operable to execute computer-readable instructions and/or mobile applications. In some implementations, cardholder mobile device 140 may execute a cardholder mobile application that is configured to generate a user interface and prompt the cardholder for the second identification information (e.g., PIN), transaction identifier, and/or other information via the user interface, as depicted in FIG. 3, for example. In some implementations, the cardholder mobile application may prompt the cardholder to manually enter the PIN, transaction identifier, and/or other information. In some implementations, the cardholder/cardholder mobile device 140 may be provided with the transaction identifier by the merchant/merchant mobile device 110.

In some implementations, the cardholder mobile application may encrypt the second identification information and may cause the encrypted second identification information to be communicated to adaptive payment server 130 via network 120. In some implementations, cardholder mobile device 140 may include a memory (not otherwise illustrated in the Figures) that includes one or more tangible (i.e., non-transitory) computer readable media. The memory may include one or more instructions that when executed by the processor configures the processor to perform functions of cardholder mobile device 140/cardholder mobile application.

In some implementations, the cardholder mobile application may cause the communication of location information associated with the cardholder mobile device 140 (referred to as “cardholder location information”) to the adaptive payment server 130 via network 120. In some implementations, the cardholder mobile application may determine the location of the cardholder mobile device 140 while the POS payment transaction is taking place at the merchant location (for example, the brick-and-mortar location). In some implementations, the cardholder location information may be communicated to the adaptive payment server 130 along with the encrypted second identification information. In some implementations, the cardholder location information may include, the GPS location coordinates of the cardholder mobile device 140, date and time (which would also indicate the date and time of the POS payment transaction, for example).

In some implementations, merchant mobile device 110 communicates the encrypted first identification information (and/or other information, for example, the GPS location coordinates of the merchant mobile device, and/or other information) and cardholder mobile device 140 communicates the encrypted second identification information (and/or other information, for example, the GPS location coordinates of the cardholder mobile device, the transaction identifier, and/or other information) to adaptive payment server 130 for processing the POS payment transaction.

In some implementations of the invention, adaptive payment server 130 may receive the encrypted first identification information and the encrypted second identification information. In some implementations, adaptive payment server 130 may determine whether the encrypted first identification information and the encrypted second identification information (received separately from the merchant mobile device 110 and cardholder mobile device 140, respectively) are associated with another.

In some implementations, adaptive payment server 130 may determine whether the first identification information and the second identification information are associated with one another based on proximity of the merchant mobile device 110 and cardholder mobile device 140, the transaction identifier, and/or other information.

In some implementations, adaptive payment server 130 may determine whether the first identification information and the second identification information are associated with one another based on the proximity of the merchant mobile device 110 and cardholder mobile device 140. In some implementations, adaptive payment server 130 may determine the proximity of the merchant mobile device 110 and cardholder mobile device 140 based on the location information received from the merchant mobile device 110 and the cardholder mobile device 140, respectively. For example, when the cardholder is at the merchant's retail location, the proximity information may indicate that the merchant mobile device 110 and cardholder mobile device 140 are located in the same area (i.e., within a predetermined distance of one another). The location information (e.g., coordinates, date and/or time) from the respective mobile devices (i.e., merchant location information and cardholder location information) may be compared to determine proximity information and/or to determine whether the date/time information matches. In some implementations, adaptive payment server 130 may determine that the first identification information and the second identification information are associated with the same POS payment transaction (i.e., are associated with one another) based on the proximity information and/or a positive match.

In some implementations, adaptive payment server 130 may determine whether the first identification information and the second identification information are associated with one another based on the transaction identifier.

In some implementations, adaptive payment server 130 generates the transaction identifier in response to receiving first identification information from merchant mobile device 110. The adaptive payment server 130 may communicate the transaction identifier to the merchant mobile device 110. Merchant mobile device 110 may receive the transaction identifier from adaptive payment server 130 and may provide (manually or electronically via network 120) the transaction identifier to the cardholder/cardholder mobile device 140. When prompted, cardholder may input the transaction identifier into the user interface of the cardholder mobile device 140 (as depicted in FIG. 3). The cardholder mobile device 140 may provide the entered transaction identifier to the adaptive payment server 130. Adaptive payment server 130 may compare the received transaction identifier with a list of transaction identifiers, wherein each of transaction identifier in the list includes a transaction identifier that was previously generated and sent by the adaptive payment server 130 to one or more merchant mobile devices. In some implementations, the list of transaction identifiers may be stored in memory 135 or database 160. In some implementations, adaptive payment server 130 may retrieve the list of transaction identifiers from memory 135 or database 160 and compare the received transaction identifier with the list. In some implementations, adaptive payment server 130 may determine that the first identification information and the second identification information are associated with the same POS payment transaction (i.e., are associated with one another) based on a positive match.

In some implementations, once a determination is made that the first identification information and the second identification information are associated with one another, adaptive payment server 130 may decrypt the encrypted first identification information and the encrypted second identification information for processing the POS payment transaction.

In some implementations, based on the decrypted first identification information and the decrypted second identification information, system 100 may initiate authentication and/or processing of the POS payment transaction. The initiation may include, among other things, authorizing and/or settling the POS payment transaction with various financial networks, sending the first and the second identification information to a remote server for further payment processing, and/or taking other actions to initiate authentication and/or payment of the payment transaction.

According to various implementations of the invention, adaptive payment server 130 may be communicably coupled to a variety of financial networks, financial institutions, and/or other entities that authorize and settle POS payment transactions using payment cards. In this manner, adaptive payment server 130 may provide processing of POS payment transactions using a robust array of payment devices and the respective financial institutions that issue, authorize, and settle payments originating from use of the payment devices.

In some implementations, adaptive payment server 130 may determine whether the POS payment transaction is authorized based on the first identification information and/or second identification information. In some implementations, adaptive payment server 130 may decrypt the first identification information and the second identification information. In some implementations, adaptive payment server 130 may determine a payment account associated with the decrypted first identification information. In some implementations, the payment account may include a bank account, debit account, and/or other financial account associated with the cardholder. According to various implementations of the invention, adaptive payment server 130 may query database 160 to identify the payment account based on the decrypted first identification information.

In some implementations, database 160, which may include information related to a payment account, such as, for example, credit card numbers, debit card numbers, cardholder contact information, cardholder information, an identity of cardholder mobile device 140 used by the cardholder (for example device identifier), and/or other information. In some implementations, database 160 may store the first identification information and the second identification information along with the payment account information. In some implementations, database 160 may store the encrypted first and second identification information. In some implementations, the second identification information and/or the encrypted second identification information may be removed from database 160 when no longer needed in order to maintain security of the second identification information. According to various implementations of the invention, examples of database 160, include, for instance, a relational database, a filesystem, and/or other device or data representation configured for data storage.

According to various implementations of the invention, adaptive payment server 130 may authenticate identification of the payment account based on the second identification information. In other words, based on the second identification information (e.g., PIN information) received from cardholder mobile device 140, adaptive payment server 130 may ensure that the payment account belongs to the cardholder. In some implementations, adaptive payment server 130 may communicate with the cardholder's bank to verify that the second identification information is associated with the payment account.

In some implementations, database 160 may have previously stored the first identification information and second identification information associated with the cardholder (prior to receiving the first identification information from the merchant mobile device 110 and second identification information from the cardholder mobile device 140). In some implementations, adaptive payment server 130 may query database 160 to retrieve the second identification information previously stored therein and compare the stored second identification information with the received and decrypted second identification information. In other words, the second identification information stored in database 160 may be compared to the second identification information received via cardholder mobile device 140 and decrypted by adaptive payment server 130. In response to a match, adaptive payment server 130 may determine that the payment account belongs to the cardholder (i.e., identify the payment account as being authentic).

According to various implementations of the invention, in response to authenticating the identification of the payment account, adaptive payment server 130 may determine that the POS payment transaction is authorized. In some implementations, in response to the authorization, adaptive payment server 130 may initiate a debit of the payment amount from the identified payment account.

In some implementations, adaptive payment server 130 may communicate a sale receipt for the payment transaction to the merchant mobile device 110 and/or cardholder mobile device 140. In some implementations, adaptive payment server 130 may retrieve the transaction identifier associated with the POS payment transaction and include the transaction identifier in the sales receipt. The sales receipt may indicate that the POS payment transaction is approved (authorized) and the payment amount for which the payment transaction is approved.

In some implementations, when an indication is provided to the cardholder that the payment card swipe has been successful, the merchant mobile application executed by the merchant mobile device 110 may prompt the cardholder to select a communication method via which the cardholder would like to receive the sale receipt. For example, the cardholder may be prompted to enter a telephone number, an email address, and/or any other communication method. The sale receipt may be communicated by electronic mail if the cardholder entered an email address. The sale receipt may be communicated by an SMS (short message service) if a telephone number is entered. In some implementations, the cardholder mobile application executed by cardholder mobile device 140 may prompt the cardholder to select a communication method via which the cardholder would like to receive the sale receipt.

In some implementations, adaptive payment server 130 may process a payment transaction by generating an EFT request to an EFT payment network. Upon processing the payment transaction, adaptive payment server 130 communicates a result of the POS payment transaction to merchant mobile device 110, which presents the results.

In some implementations of the invention, the POS payment transaction may be processed via an EFT network. In these implementations, processing the payment transaction may include generating a funds transfer request or balance inquiry request to an EFT provider (via EFT provider computer 150) such as, without limitation, SHAZAM, NYCE, PULSE, STAR, INTERLINK, and/or other entity that provides EFTs. In these implementations, adaptive payment server 130 may communicate an EFT request associated with the financial account based on the first identification information and the second identification information. In some implementations of the invention, the EFT request may include, without limitation, an ISO 8583 payment message supported by various EFT networks. As would be appreciated, each network may adapt the ISO 8583 standard for its own use with custom fields and custom usages. As would be further appreciated, the placement of fields in different versions (such as 1987, 1993 and 2003) of the standard varies. In some implementations, one EFT network may act as a gateway to other EFT networks to provide universal coverage.

In some implementations, adaptive payment server 130 may cause the amount of funds to be transferred based on the EFT request. In some implementations of the invention, the EFT is processed by or otherwise fulfilled by an EFT provider (such as via EFT provider computer 150).

In some implementations of the invention, adaptive payment server 130 may receive an indication of an amount of funds (for example, payment amount) to be transferred. In these implementations, adaptive payment server 130 may receive a target account identifier that indicates a target account to which the amount of funds should be transferred. In some implementations, adaptive payment server 130 may cause the amount of funds to be transferred from the payment account to the target account. Adaptive payment server 130 may do so by generating, for example, an EFT request that indicates the payment account, the target account, the PIN, and amount of funds to be transferred.

In some implementations of the invention, upon completion of processing of a POS payment transaction, a receipt may be communicated to the cardholder. In some implementations, the receipt may be communicated via SMS text or electronic mail. In some implementations, the receipt may include various transaction data such as, without limitation, a name of the retailer/merchant where the transaction was processed, a location/address of the retailer, an account identifier such as a card number, a terminal number where the transaction was processed, a date, a time, a sequence number or other transaction identifier, a type of transaction (such as “purchase”), a monetary amount of the transaction, a ledger balance associated with the account, and an available balance associated with the account.

In some implementations of the invention, merchant mobile device 110, cardholder mobile device 140, adaptive payment server 130, or other client computing device may store a history of transactions. The history may include, without limitation, a phone number, an account identifier such as a card number, a date, a time, a sequence number, a type of transaction (such as “purchase”), a monetary amount of the transaction, and a response indicator (such as “text response”). In this manner, a merchant, a cardholder, or other operators of these devices may have a log of transactions in the event that a particular transaction is questioned.

In some implementations, adaptive payment server 130 may include a processor 132, a memory 135, and/or other components that facilitate the functions of adaptive payment server 130. In some implementations, processor 132 includes one or more processors configured to perform various functions of adaptive payment server 130. In some implementations, memory 135 includes one or more tangible (i.e., non-transitory) computer readable media. Memory 135 may include one or more instructions that when executed by processor 132 configure processor 132 to perform functions of adaptive payment server 130. In some implementations, memory 135 may include one or more instructions stored on tangible computer readable media that when executed at a remote device, such as merchant mobile device 110 and/or cardholder mobile device 140, cause the remote device to perform various functions of the remote device described herein and to facilitate interaction with adaptive payment server 130, as described herein.

In some implementations of the invention, adaptive payment server 130 may cause the merchant mobile application to be downloaded to merchant mobile device 110. In some implementations of the invention, adaptive payment server 130 may cause the cardholder mobile application to be downloaded to cardholder mobile device 140. For example, the instructions associated with the mobile applications may be stored within memory 135 or other accessible memory location of adaptive payment server 130.

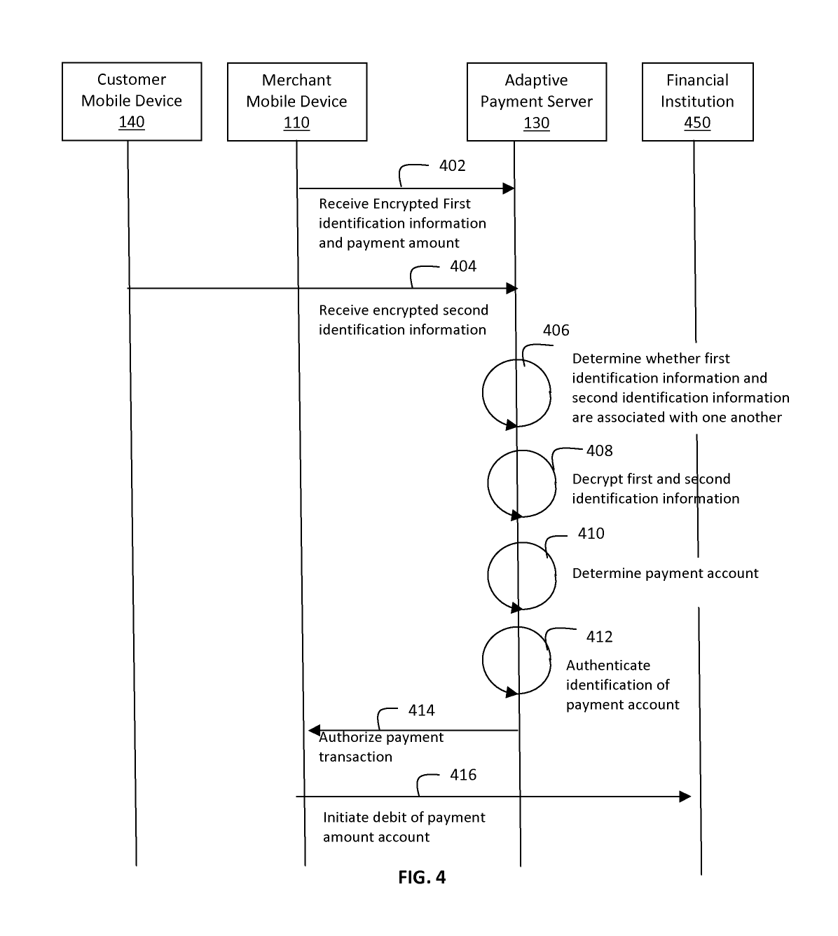

FIG. 4 is a data flow diagram illustrating exemplary process relationships in a system for processing payment transactions, according to various implementations of the invention. Adaptive payment server 130 may receive encrypted first identification information (for example, payment card number) from merchant mobile device 110 in operation 402. In some implementations, adaptive payment server 130 may receive a payment amount associated with a POS payment transaction along with the encrypted first identification information in operation 402. In some implementations, adaptive payment server 130 may receive encrypted second identification information (for e.g., PIN) from cardholder mobile device 140 in operation 404.

In some implementations, in an operation 406, adaptive payment server 130 may determine whether the first identification information and the second identification information are associated with one another. In some implementations, adaptive payment server 130 may make the determination based on location information associated with the merchant mobile device 110 and the cardholder mobile device 140 (for example, proximity information and/or date/time information comparison), the transaction identifier, and/or other information.

In some implementations, adaptive payment server 130 may decrypt the first identification information and the second identification information, in an operation 408. In some implementations, in an operation 410, adaptive payment server may determine a payment account associated with the cardholder based on the decrypted first identification information. In some implementations, adaptive payment server 130 may authenticate the identified payment account, in operation 412. In some implementations, adaptive payment server 130 may authenticate the identified payment account based decrypted second identification information.

In some implementations, adaptive payment server 130 may authorize the payment transaction and communicate the authorization (in the form of a sales receipt, for example) to cardholder mobile device in operation 414. In some implementations, in an operation 416, adaptive payment server 130 may provide a request to initiate a debit of the payment amount from the payment account associated with the financial institution 450 (such as a bank) where the cardholder has the payment account. In some implementations, adaptive payment server 130 may initiate a fund transfer request to an EFT provider requesting debit of the payment amount from the payment account. In some implementations, the adaptive payment server 130 may cause the payment amount to be transferred based on the EFT request.

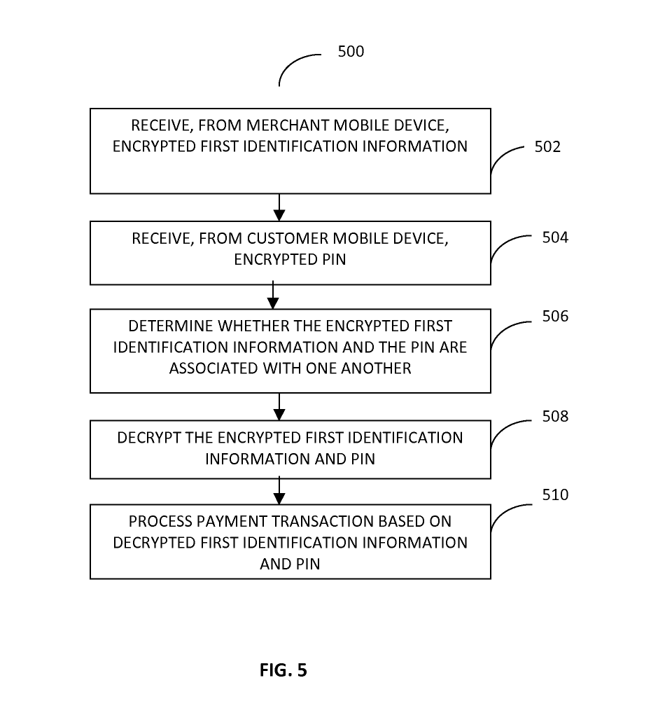

FIG. 5 is a flow diagram illustrating a process 500 for processing a POS payment transaction via a mobile device (performed by the adaptive payment server 130, for example), according to various implementations of the invention. The various processing operations and/or data flows depicted in FIG. 5 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In some implementations of the invention, in an operation 502, process 500 may include receiving, from a merchant mobile device 110, encrypted first identification information that identifies a payment account to be used for the POS payment transaction, a payment amount, and/or other information.

In some implementations of the invention, in an operation 504, process 500 may include receiving, from a cardholder mobile device 140, an encrypted PIN associated with the payment account. The PIN is used to authenticate the POS payment transaction.

In some implementations of the invention, in an operation 506, process 500 may include determining whether the encrypted first identification information and the encrypted PIN are associated with one another (i.e., associated to the same POS payment transaction).

In some implementations of the invention, in an operation 508, process 500 may include decrypting the encrypted first identification information and the encrypted PIN. In some implementations, process 500 may decrypt the encrypted first identification information and the encrypted PIN in response to a determination that the encrypted first identification information and the encrypted PIN are associated with one another. In some implementations of the invention, in an operation 510, process 500 may include processing the POS payment transaction based on the decrypted first identification information and the decrypted PIN.

Implementations of the invention may be made in hardware, firmware, software, or any suitable combination thereof. Implementations of the invention may also be implemented as instructions stored on a machine-readable medium, which may be read and executed by one or more processors. A tangible (non-transitory) machine-readable medium may include any mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. An adaptive payment server for processing a POS payment transaction comprising:
a processor configuring the server to:
receive, from a merchant mobile device, an encrypted first identification information that identifies a payment account and a payment amount;
receive, from a cardholder mobile device, encrypted second identification information that is used to authenticate the POS payment transaction;
determine whether the encrypted first identification information and the encrypted second identification information are associated with one another;
decrypt the encrypted first identification information and the encrypted second identification information; and
process the POS payment transaction based on the decrypted first identification information and the decrypted second identification information.

2. The adaptive payment server of claim 1, wherein the encrypted first identification information includes an encrypted debit card number.

3. The adaptive payment server of claim 1, wherein the encrypted second identification information includes an encrypted Personal Identification Number (“PIN”).

4. The adaptive payment server of claim 1, wherein the server configured to determine whether the encrypted first identification information and the encrypted second identification information are associated with one another is further configured to:
receive merchant location information associated with the merchant mobile device;
receive cardholder location information associated with the cardholder mobile device;
determine proximity of the merchant mobile device and the cardholder mobile device based on the merchant location information and the cardholder location information; and
determine whether the encrypted first identification information and the encrypted second identification information are associated with one another based on the determined proximity.

5. The adaptive payment server of claim 1, wherein the server is further configured to:
in response to receiving the encrypted first identification information, generate a transaction identifier that uniquely identifies the POS payment transaction; and
communicate the transaction identifier to the merchant mobile device.

6. The adaptive payment server of claim 1, wherein the server configured to determine whether the encrypted first identification information and the encrypted second identification information are associated with one another is further configured to:
receive, from the cardholder mobile device, a transaction identifier associated with the POS payment transaction;
compare the received transaction identifier with a list of transaction identifiers, wherein each transaction identifier in the list of transaction identifier comprises a transaction identifier communicated by the server to one or more merchant mobile devices;
determine whether the encrypted first identification information and the encrypted second identification information are associated with one another based on the comparison.

7. The adaptive payment server of claim 1, wherein the server is further configured to:
authenticate identification of the payment account based on the second identification information; and
initiate a debit of the payment amount from the identified account.

8. The adaptive payment server of claim 1, wherein the server is configured to process the POS payment transaction via an EFT network.

9. The adaptive payment server of claim 8, wherein the server is configured to generate an EFT request to the EFT network.

10. The adaptive payment server of claim 1, wherein the first identification information and the second identification information are encrypted using the same encryption technique.

11. A method for processing a POS payment transaction, the method comprising:
receiving, from a merchant mobile device, an encrypted first identification information that identifies a payment account and a payment amount;
receiving, from a cardholder mobile device, encrypted second identification information that is used to authenticate the POS payment transaction;
determining whether the encrypted first identification information and the encrypted second identification information are associated with one another;
decrypting the encrypted first identification information and the encrypted second identification information; and
processing the POS payment transaction based on the decrypted first identification information and the decrypted second identification information.

12. The method of claim 11, wherein the encrypted first identification information includes an encrypted debit card number.

13. The method of claim 11, wherein the encrypted second identification information includes an encrypted Personal Identification Number (“PIN”).

14. The method of claim 11, wherein said determining whether the encrypted first identification information and the encrypted second identification information are associated with one another further comprising:
receiving merchant location information associated with the merchant mobile device;
receiving cardholder location information associated with the cardholder mobile device;
determining proximity of the merchant mobile device and the cardholder mobile device based on the merchant location information and the cardholder location information; and
determining whether the encrypted first identification information and the encrypted second identification information are associated with one another based on the determined proximity.

15. The method of claim 11, further comprising:
in response to receiving the encrypted first identification information, generating a transaction identifier that uniquely identifies the POS payment transaction; and
communicating the transaction identifier to the merchant mobile device.

16. The method of claim 11, wherein said determining whether the encrypted first identification information and the encrypted second identification information are associated with one another further comprising:
receiving, from the cardholder mobile device, a transaction identifier associated with the POS payment transaction;
comparing the received transaction identifier with a list of transaction identifiers, wherein each transaction identifier in the list of transaction identifier comprises a transaction identifier communicated by the server to one or more merchant mobile devices;
determining whether the encrypted first identification information and the encrypted second identification information are associated with one another based on the comparison.

17. The method of claim 11, further comprising:
authenticating identification of the payment account based on the second identification information; and
initiating a debit of the payment amount from the identified account.

18. The method of claim 11, wherein the POS payment transaction is processed via an EFT network.

19. The method of claim 18, wherein the POS payment transaction is processed by generating an EFT request to the EFT network.

20. The method of claim 11, wherein the first identification information and the second identification information are encrypted using the same encryption technique.
